(19) United States
(12) Patent Application Publication
(10) Pub. No.: US 2013/0045423 A1
(43) Pub. Date: Feb. 21, 2013

(54) POROUS CONDUCTIVE ACTIVE COMPOSITE ELECTRODE FOR LITIHIUM ION BATTERIES

(71) Applicants: Pau Yee LIM, Hong Kong (HK); Yingkai JIANG, Shenzhen (CN); Dennis McKean, Hong Kong (HK)

(72) Inventors: Pau Yee LIM, Hong Kong (HK); Yingkai JIANG, Shenzhen (CN); Dennis McKean, Hong Kong (HK)

(73) Assignee: Hong Kong Applied Science and Technology Research Institute Company Limited, Hong Kong (HK)

(21) Appl. No.: 13/213,079

(22) Filed: Aug. 18, 2011

(51) Int. Cl. H01M 4/13; H01B 1/12; H01B 1/04; H01M 4/04

(52) U.S. Cl. 429/231.5; 429/218.1; 429/231.8; 252/511; 252/512

(57) ABSTRACT

A composite lithium ion battery electrode is formed from an active composite material dispersed in a conductive porous matrix formed over a current collector. The active composite material includes nano-clusters of an active material dispersed on a conductive skeleton structure. The active material is a metal-based material including one or more of Sn, Al, Si, Ti or a carbon-based material including one or more of graphite, carbon fibers, carbon nanotubes (CNT) or combinations thereof, having a particle size ranging from approximately 1 nanometers to approximately 10 microns. The conductive skeleton includes a conductive polymer or a conductive filament. The active material is dispersed on the conductive skeleton through an in situ polymerization process or a chemical grafting process. The conductive porous matrix includes a conductive polymeric binder and lithium ion diffusion channels created by a pore-forming agent. Conductive particles are further included in the conductive porous matrix.

### FIELD OF THE INVENTION

The present invention relates to electrodes for lithium ion batteries and, more particularly, to electrodes that include active composite materials dispersed in a porous conductive polymer matrix having channels for lithium ion diffusion.

### BACKGROUND

Lithium ion batteries are used in numerous portable electronic devices such as mobile telephones and laptop computers. Although lithium ion batteries have adequate characteristics for portable electronic devices, batteries for electronic vehicles typically require higher capacity than those currently available. Different approaches have been used to increase the capacity of lithium ion batteries, including formation of porous anodes and composite anodes are disclosed in U.S. Patent Publication Nos. 2011/0114254, 2008/0237536, 2010/0021819, 2010/0119942, 2010/0143798, 2010/0285365, and 2010/0062338, WO 2008/021961, and EP 1 207 572. While such anodes can improve battery performance, there remains a need in the art for improved lithium ion battery electrodes that can be easily and inexpensively mass-produced for large scale use in electric vehicles and portable electronic devices.

### SUMMARY OF THE INVENTION

The present invention relates to a composite lithium ion battery electrode formed from an active composite material dispersed in a conductive porous matrix formed over a current collector. The active composite material includes nano-clusters of an active material dispersed on a conductive skeleton structure. The active material is selected from fine particles including Sn, Al, Si, Ti and C and having a particle size ranging from approximately 1 nanometer to approximately 10 microns. The conductive skeleton includes at least a conductive polymer or a conductive filament. The active material is dispersed on the conductive skeleton through an in situ polymerization process or a chemical grafting process.

The conductive porous matrix includes a conductive polymeric binder and lithium ion diffusion channels created by a pore-forming material during mixture of the active composite material in the conductive porous matrix. Conductive particles are further included in the conductive porous matrix.

### BRIEF DESCRIPTION OF THE DRAWINGS

FIG. 1 is a schematic representation of a composite lithium ion battery electrode according to one embodiment of the present invention.

FIG. 2 is a schematic representation of an active composite material used in the electrode of FIG. 1.

### DETAILED DESCRIPTION

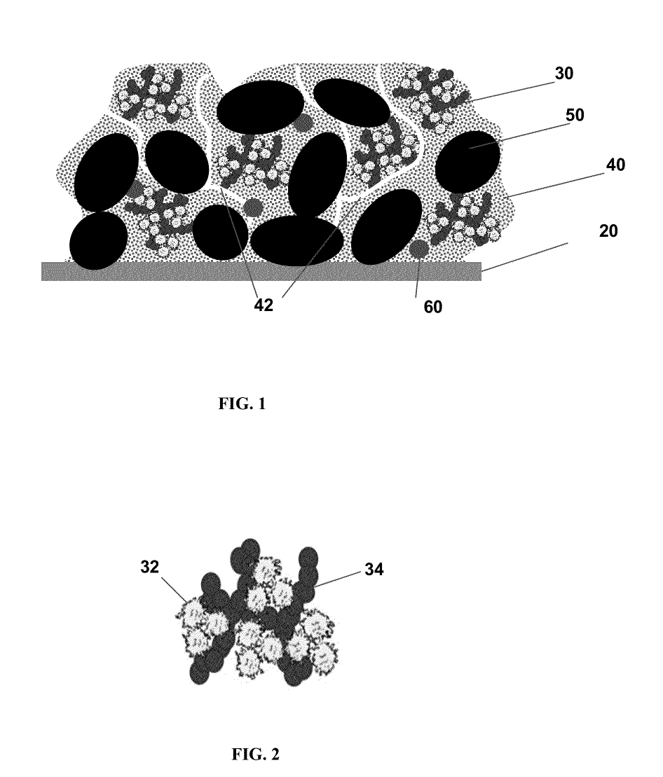

Turning to the drawings in detail, FIG. 1 depicts a composite lithium ion battery electrode 10 according to the invention. In the embodiment of FIG. 1, the electrode includes a current collector 20, typically a conductive metal plate such as copper. Disposed on the current collector 20 is an active composite material 30 dispersed in a conductive porous matrix 40. The active composite material includes fine particles of an active material 32, best seen in FIG. 2, dispersed on a conductive skeleton structure 34. Active material 32 has fine particulate structure with a particle size ranging from approximately 1 nanometer to approximately 10 microns. When the electrode is used as an anode, the particles include metal-based materials such as Sn, Al, Si, Ti or carbon-based materials such as graphite, carbon fiber, carbon nanotube (CNT) or combinations thereof. In the anode, these materials offer superior intercalation media for lithium ions during the charging phase. During discharge, lithium ions are transported from the anode to the cathode. Due to volume change incurred during the insertion and removal of lithium ions, solid metal active materials are subject to fractionation (breaking into smaller particles) after repeated charging and discharging cycles. The use of nano-scale particulate active materials advantageously avoids this problem and also provides a greater surface area for lithium intercalation.

Conductive skeleton 34 includes at least a conductive polymer or a conductive filament, with the active material 32 being dispersed on the conductive skeleton through an in situ polymerization process or a chemical grafting process (to be discussed below). By segregating the active material to the conductive skeleton in this manner, agglomeration of the active material in the porous conductive matrix 40 is avoided consequently increasing the manufacturability of the present invention for large-scale production.

Exemplary conductive polymers for conductive skeleton 34 include pyrrole, anilline, or thiofuran; alternatively, conductive filaments such as carbon nanotubes or carbon nanofibers can be used as the skeleton 34. As seen in FIG. 2, the open structure of skeleton 34 combined with dispersed active material 32 creates micro-diffusion channels for lithium ions, enhancing the intercalation of active material 32. The capacity of the resultant battery is increased through the structure of the active composite 30. The micro-channels also help accommodate the expansion and contraction of the active material particles as lithium ions are inserted and removed during charging and discharging.

Active composite 30 is dispersed in a conductive porous matrix 40 as seen in FIG. 1. The conductive porous matrix 40 includes a conductive polymeric binder and lithium ion diffusion channels 42 created by a pore-forming material during mixture of the active composite material in the conductive porous matrix (to be discussed below). The conductive polymeric binder is selected from one or more of modified pyrrole, aniline, and thiofuran or other suitably conductive polymers, particularly those that have an electrical conductivity of greater than about 10 S/cm. The lithium ion channels 42 advantageously provide lithium transport access to the active material 32. Further, channels 42 help accommodate the expansion and contraction of the overall composite electrode as lithium ions are added or removed during charging and discharging, respectively. In one embodiment, the channels are selected to have a volume percentage of less than 5% of the electrode.

To enhance the conductivity of porous matrix 40, at least one type of conductive particle such as particles 50 or 60 are included in the conductive porous matrix. In the embodiment of FIG. 1, particles 50 are graphite and particles 60 are carbon black; however, other conductive particles may also be selected for use in porous matrix 40.

An exemplary method for fabricating electrode 10 is described. Formation of active composite material 30 includes precipitation of an active material 32 such as Sn, Al, Si, or Ti from a suitable precursor solution such as Sn, Al, Si, or Ti precursor salts (nitrates, carbonates, etc.) Precursor solutions are mixed with additives such as sulfonates, imines, and nitrides followed by dehydration to obtain a precipitate precursor powder having a particle size on the order of 1-100 microns. Thermal treatment of the precipitate at a temperature of less than 1000° C. in air or an inert environment produces a reduced/calcined powder of the active material; grinding and milling reduces the particle size to a range of less than 100 microns, preferably approximately 1 nm to 10 microns. This technique facilitates reproducible and cost-effective mass production of the electrode active material.

To form a dispersed active material 32 on a skeleton structure 34 several techniques may be selected. In one technique, carbon fibers, nanotubes, and/or rods are surface-treated to produce a —COOH group bound to the carbon-based skeleton. The fine particles of active material are mixed with additives such as APTES (aminopropyltriethoxy silane), APTMS (3-aminopropyltrimethoxysilane), or APPA (2-amino-5-phosphoro-3 pentenoic acid) and rinsed and dried to form an activated active material powder. To form the —COOH groups on the carbon skeleton structure, the carbon skeleton structure is mixed with a reagent such as EDC (N-(3-dimethylaminopropyl)-N′-ethylcarbodiimide) or NHS (N-hydroxysulfosuccinimide). The carbon-based skeleton with —COOH groups is mixed in solution with the activated active material powder to chemically bind the active material to the carbon-based skeleton.

In an alternative embodiment for forming the active material dispersed on a skeleton, in-situ polymerization is used. The fine particles of Sn, Al, Si, or Ti are mixed with an additive such as sulfonic acid, sodium salt, or sulfonates. This mixture is added to a polymerization solution including pyrrole, aniline, or thiofuran; an additive selected from materials such as ferric trichloride or ammonium sulfate is added. Polymerization preferable occurs at a temperature of less than approximately 10° C. in a de-aerated solution. The resulting active material composite material includes the active material dispersed in a porous skeleton.

By preparing an active material composite, the fine particles of active material are dispersed on the substrate skeleton. The skeleton can then be incorporated in the conductive porous matrix without agglomeration of the active material particles, ensuring a large surface area of active material for lithium intercalation. To create the conductive porous matrix, a conductive polymer such as one or more of pyrrole, aniline, or thiofuran is surface-modified to create a binder that will bind with the active material composite. The active material composite, the conductive polymer binder and a pore-forming agent that is either a pore-forming material and/or vesicant material such as carbonate salt, (NH₄)₂CO₃, or C₂H₄N₄O₂ are mixed together, along with further conductive particles such as particles 50 and/or 60 (graphite, carbon black). The mixture is applied to current collector 20 such as a copper plate and the gas is evacuated and the solvent evaporated, leaving behind the porous conductive matrix with the active material composite dispersed therein. The pore-forming material(s) result in in-situ pore formation, creating continuous interconnecting porous channels for enhancing lithium ion transport.

While the foregoing invention has been described with respect to various embodiments, such embodiments are not limiting. Numerous variations and modifications would be understood by those of ordinary skill in the art. Such variations and modifications are considered to be included within the scope of the following claims.

1. A composite lithium ion battery electrode comprising:
an active composite material dispersed in a conductive porous matrix formed over a current collector, the active composite material comprising active material dispersed on or in a conductive skeleton structure, the active material selected from fine particles having a particle size less than approximately 10 microns and including at least one material selected from either a metal-based material including one or more of Sn, Al, Si, Ti or a carbon-based material including one or more of graphite, carbon fiber, carbon nanotube (CNT) or combinations of the metal-based material and the carbon based material, and the conductive skeleton includes at least a conductive polymer or a conductive filament, the active material being dispersed on the conductive skeleton through an in situ polymerization process or a chemical grafting process;
the conductive porous matrix including a conductive polymeric binder and lithium ion diffusion channels created by a pore-forming agent during mixture of the active composite material in the conductive porous matrix, the conductive porous matrix further including particulate conductive particles.

2. A composite lithium ion battery electrode according to claim 1 wherein the current collector is a copper sheet.

3. A composite lithium ion battery electrode according to claim 1 wherein the conductive particles are carbon black and/or graphite.

4. A composite lithium ion battery electrode according to claim 1 wherein the conductive skeleton is a carbon fiber.

5. A composite lithium ion battery electrode according to claim 1 wherein the conductive skeleton is a carbon nanotube.

6. A composite lithium ion battery electrode according to claim 1 wherein the electrode is an anode.

7. A composite lithium ion battery electrode according to claim 1 wherein the conductive polymeric binder includes one or more of pyrrole, aniline, or thiofuran.

8. A composite lithium ion battery electrode according to claim 1 wherein the pore forming agent is includes at least one of a pore-forming material or vesicant material.

9. A method of making the composite lithium ion battery electrode of claim 1 in which the metal-based active material is formed by precipitating one or more of Sn, Al, Si, or Ti from a precursor solution of Sn, Al, Si, or Ti precursor salts or mixtures thereof, the precursor solutions being mixed with additives selected from one or more of sulfonates, imines, or nitrides, the precipitates being dehydrated to obtain a precipitate precursor powder having a particle size on the order of 1-100 microns followed by thermal treatment at a temperature of approximately less than 1000° C. in air or an inert environment to produce a reduced/calcined powder of the active material and further grinding or milling or a combination thereof to reduce a particle size of the active material to less than approximately 100 microns.

10. A method of making the composite lithium ion battery electrode of claim 1 wherein the particle size of the active material is in a range of approximately 1 nm to 10 microns.

11. A method of making the active composite material of the composite lithium ion battery electrode of claim 1 comprising activating a skeleton material including carbon fibers, carbon nanotubes, or carbon rods with a reagent to form —COOH groups bound to the skeleton material and mixing fine particles of active material with one or more additives to form an activated active material powder followed by mixing the skeleton material with bound —COOH groups in solution with the activated active material powder to chemically bind the active material to the skeleton material.

12. A method of making the active composite material of the composite lithium ion battery electrode of claim 1 comprising mixing fine particles of the active material to a polymerization solution including a conductive polymer to disperse the active material with a porous conductive skeleton.

13. A method according to claim 12 wherein the conductive polymer includes one or more of pyrrole, aniline, or thiofuran.

14. A method of making the composite lithium ion battery electrode of claim 1 comprising forming the active composite material by dispersing the active material on or in a conductive skeleton and adding the active composite material to a mixture including a conductive polymer, the conductive polymer having been surface-modified to create a binder that will bind with the active material composite to form a conductive polymeric binder, and further including a pore-forming agent selected from a pore-forming material or vesicant material or combinations thereof and further including conductive particles and applying the mixture to the current collector to create a porous conductive matrix with the active composite material and conductive particles dispersed therein.

15. The method according to claim 14 wherein the conductive polymer includes one or more of modified pyrrole, aniline, or thiofuran.
